(19) United States
(12) Patent Application Publication
(10) Pub. No.: US 2026/0056664 A1
(43) Pub. Date: Feb. 26, 2026

(54) DATA PROCESSING METHOD AND DEVICE BASED ON MULTI-MESSAGE QUEUE SYSTEM

(71) Applicant: Beijing Volcano Engine Technology Co., Ltd., Beijing (CN)

(72) Inventors: Guodong YANG, Beijing (CN); Changli GAO, Beijing (CN)

(21) Appl. No.: 19/305,674

(22) Filed: Aug. 20, 2025

(30) Foreign Application Priority Data
Aug. 20, 2024 (CN) 202411148250.X

(51) Int. Cl. G06F 3/06

(52) U.S. Cl. CPC G06F 3/0613; G06F 3/0659; G06F 3/0673

(57) ABSTRACT

Embodiments of the present disclosure provide a data processing method and a device based on a multi-message queue system, the method includes: receiving a data read request, where the data read request is used to request to read first target data; if the data read request belongs to an instant service scenario, reading the first target data from a first message queue system in a heterogeneous multi-message queue system by using a data access interface of the first message queue system to respond; and if the data read request belongs to an intensive service scenario, reading the first target data from a second message queue system in the heterogeneous multi-message queue system by using a data access interface of the second message queue system to respond.

### CROSS-REFERENCE TO RELATED APPLICATION(S)

This application claims priority to Chinese Application No. 202411148250.X filed Aug. 20, 2024, the disclosure of which is incorporated herein by reference in its entirety.

### FIELD

Embodiments of the present disclosure relate to the field of cloud networks technology, and in particular, to a data processing method and device based on a multi-message queue system.

### BACKGROUND

A message is a data unit transmitted between two computers. The message may be very simple, for example, including only a text character string, or may be more complex and may include an embedded object. A message queue system is a container for storing messages in a message transmission process. Messages may be sent to the message queue system, and the message queue system needs to provide storage and delivery functions for the messages. A main purpose of the message queue system is to provide message routing and ensure message delivery: If a recipient is unavailable when a message is sent, the message queue will keep the message until the message can be successfully delivered.

### SUMMARY

Embodiments of the present disclosure provide a data processing method and device based on a multi-message queue system, which can improve processing efficiency of a data request.

In a first aspect, an embodiment of the present disclosure provides a data processing method based on a multi-message queue system, including:
receiving a data read request, where the data read request is used to request to read first target data:
if the data read request belongs to an instant service scenario, reading the first target data from a first message queue system in the multi-message queue system by using a data access interface of the first message queue system to respond, where the multi-message queue system is a heterogeneous multi-message queue system; and
if the data read request belongs to an intensive service scenario, reading the first target data from a second message queue system in the multi-message queue system by using a data access interface of the second message queue system to respond, where the multi-message queue system is a heterogeneous multi-message queue system.

In a second aspect, an embodiment of the present disclosure provides a data processing device based on a multi-message queue system, including:
a receiving unit, configured to receive a data read request, where the data read request is used to request to read first target data;
a processing unit, configured to: if the data read request belongs to an instant service scenario, read the first target data from a first message queue system in the multi-message queue system by using a data access interface of the first message queue system to respond, where the multi-message queue system is a heterogeneous multi-message queue system; and the processing unit is further configured to: if the data read request belongs to an intensive service scenario, read the first target data from a second message queue system in the multi-message queue system by using a data access interface of the second message queue system to respond, where the multi-message queue system is a heterogeneous multi-message queue system.

In a third aspect, an embodiment of the present disclosure provides an electronic device, including: a processor and a memory:
where the memory stores computer-executable instructions; and
the processor executes the computer-executable instructions stored in the memory, to enable the at least one processor to perform the data processing method based on a multi-message queue system according to the first aspect and various possible designs of the first aspect.

In a fourth aspect, an embodiment of the present disclosure provides a computer-readable storage medium, where the computer-readable storage medium stores computer-executable instructions, and when a processor executes the computer-executable instructions, the data processing method based on a multi-message queue system according to the first aspect and various possible designs of the first aspect is implemented.

In a fifth aspect, an embodiment of the present disclosure provides a computer program product, including a computer program, where when the computer program is executed by a processor, the data processing method based on a multi-message queue system according to the first aspect and various possible designs of the first aspect is implemented.

The embodiments provide a data processing method and device based on a multi-message queue system. The method includes: receiving a data read request, where the data read request is used to request to read first target data: if the data read request belongs to an instant service scenario, reading the first target data from a first message queue system in the multi-message queue system by using a data access interface of the first message queue system to respond, where the multi-message queue system is a heterogeneous multi-message queue system; and if the data read request belongs to an intensive service scenario, reading the first target data from a second message queue system in the multi-message queue system by using a data access interface of the second message queue system to respond, where the multi-message queue system is a heterogeneous multi-message queue system.

### BRIEF DESCRIPTION OF THE DRAWINGS

In order to illustrate the technical solutions in the embodiments of the present disclosure or in the prior art more clearly; the drawings required in the description of the embodiments or the prior art will be briefly described below. Obviously, the drawings in the following description are some embodiments of the present disclosure, and other drawings may also be obtained by a person of ordinary skill in the art according to these drawings without paying any creative effort.

FIG. 1 is a schematic diagram of an application scenario of a data processing method based on a multi-message queue system according to an embodiment of the present disclosure;

FIG. 2 is a first flowchart of a data processing method based on a multi-message queue system according to an embodiment of the present disclosure:

FIG. 3 is a first schematic diagram of a data processing method based on a multi-message queue system according to an embodiment of the present disclosure:

FIG. 4 is a second schematic diagram of a data processing method based on a multi-message queue system according to an embodiment of the present disclosure:

FIG. 5 is a third schematic diagram of a data processing method based on a multi-message queue system according to an embodiment of the present disclosure:

FIG. 6 is a schematic structural diagram of a data processing device based on a multi-message queue system according to an embodiment of the present disclosure; and

FIG. 7 is a schematic structural diagram of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and completely below with reference to the drawings in the embodiments of the present disclosure. Obviously, the described embodiments are merely a part of rather than all of the embodiments of the present disclosure. All other embodiments obtained by a person of ordinary skill in the art based on the embodiments in the present disclosure without paying any creative effort shall fall within the protection scope of the present disclosure.

A message (a type of service data in the present application) is a data unit transmitted between two computers. The message may be very simple, for example, including only a text character string, or may be more complex and may include an embedded object. A message queue system is a container for storing messages in a message transmission process. Messages may be sent to the message queue system, and the message queue system needs to provide storage and delivery functions for the messages. A main purpose of the message queue system is to provide message routing and ensure message delivery. If a recipient is unavailable when a message is sent, the message queue will keep the message until the message can be successfully delivered.

With continuous growth of service data volume, service applications also have higher requirements for processing efficiency and resource overhead of a message queue system. A current message queue system generally includes a low-latency message queue system and a high-throughput message queue system. The low-latency message queue system can ensure lower write latency, and generally uses a solid-state drive for storage. The high-throughput message queue system generally uses a hard disk drive for storage, and has a performance advantage of high throughput.

However, at the beginning of designing different message systems, an architecture solution is usually designed according to a design objective thereof, which gives each message queue system its unique advantages and disadvantages.

For example, an Apache Kafka message system in the low-latency message queue system is designed to solve the problem of reliable transmission of massive data in a big data scenario at the beginning of its design, so that the Apache Kafka message system has a performance advantage of high throughput when using relatively cheap hard disk drive storage hardware. However, due to its architecture design, the number of Topics (subjects) carried in the Apache Kafka message system is relatively limited, and the cluster performance will drop sharply when there are too many Topics.

For another example, an Apache RocketMQ message system in the high-throughput message queue system is designed for scenarios of low-latency online applications such as e-commerce and microservices. While ensuring the throughput as much as possible, a unique architecture design is performed especially for a multi-Topic scenario, so that the cluster performance will not decrease rapidly with the increase of the number of Topics. In order to ensure lower write latency, the Apache RocketMQ message system mostly uses more expensive solid-state drives for storage, which is costly.

With continuous growth of service data volume, service applications also have higher requirements for processing efficiency and resource overhead of a message queue system.

In view of the technical problems in the prior art, inventors have the following technical concept: providing a hybrid storage message queue system with higher performance and lower cost by combining a data hierarchical storage method of a plurality of message queues and combining design advantages of different message queue systems. While reducing the storage cost of data, the architecture advantages of a plurality of different message queue systems are more reasonably utilized, and the system function is extended in the original message queue system.

Accordingly; the specific steps include: receiving a data read request, where the data read request is used to request to read first target data: if the data read request belongs to an instant service scenario, reading the first target data from a first message queue system in a heterogeneous multi-message queue system by using a data access interface of the first message queue system to respond; and if the data read request belongs to an intensive service scenario, reading the first target data from a second message queue system in the heterogeneous multi-message queue system by using a data access interface of the second message queue system to respond.

In the technical solution, the data access interface of the first message queue system may be used for the instant service scenario to read the first target data from the first message queue system to respond, and the data access interface of the second message queue system may be used for the intensive service scenario to read the first target data from the second message queue system to respond, so that the processing efficiency of the data request can be improved through the plurality of data access interfaces. Moreover, design advantages of different message queue systems are combined, and respective advantages of the multi-message queue system are used to effectively get through the multi-message queue system, so that a hybrid storage message queue system with higher performance and lower cost is provided, thereby saving storage resources and reducing cost overhead.

The application scenario of the embodiments of the present disclosure is explained below.

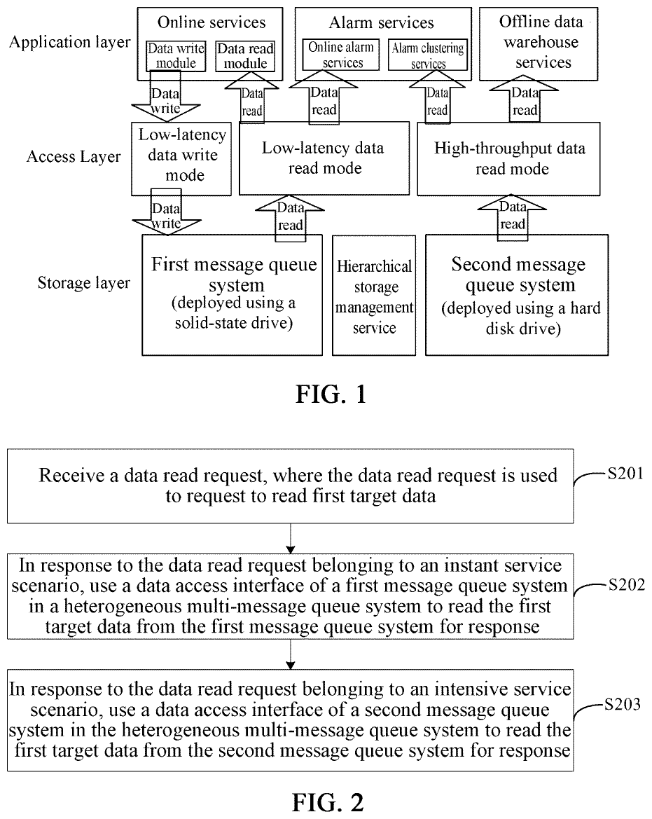

In the multi-message queue system of the embodiments of the present disclosure, as shown in FIG. 1, the multi-message queue system includes an application layer, an access layer, and a storage layer. The access layer and the storage layer are main content of the present invention, and the application layer is a demonstration of usage.

In the application layer, a data access mode (pattern) may be flexibly selected according to a service requirement of a service party. In the embodiment of the present disclosure, the multi-message queue system may select a low-latency data access mode or a high-throughput data access mode according to a service requirement scenario of the service party.

In the access layer, there are three data interaction modes: a low-latency data write mode, a low-latency data access mode, and a high-throughput data access mode. The low-latency data write mode is used for low-latency data writing. The low-latency data access mode is used for low-latency data reading. The high-throughput data access mode is used for reading a plurality of pieces of data at a time.

In the storage layer, there are three parts: a first message queue system, a second message queue system, and a hierarchical storage management service. The first message queue system is deployed with high-performance and high-cost solid-state drives to provide low-latency and high-performance data storage services. The second message queue system is deployed with cheap hard disk drives to provide larger storage space and low-cost data storage services. Data management is performed between the two storage systems by the hierarchical storage management service, and main functions of the hierarchical storage management service include: periodically writing data from the first message queue system into the second message queue system; managing the association between the data in the first message queue system and the data in the second message queue system; and providing a function of accessing historical data in the second message queue system through the first message queue system.

It should be further noted that in the multi-message queue system, by combining the two message queue systems, more heterogeneous storage replicas are provided for the service data, which increases the reliability of the service data and reduces the problem of data loss caused by hardware failure of a single system. By combining the two message queue systems, the following problems can be solved.

(1) A good balance between high performance and low cost is achieved, both high performance and low cost can be considered in the same system, and different usage schemes are provided according to different usage scenarios.

(2) The storage cost of a message per unit time is reduced. Data is classified into hot data that needs to be accessed with high performance and cold data that is stored at low cost, so as to reduce the overall storage cost of the data. A long-term data storage solution with low cost is provided.

(3) The same set of system is used to provide two data consumption scenarios: a low-latency data consumption scenario and a high-throughput data consumption scenario. For the instant service scenario (for example, the low-latency data consumption scenario), the data access interface of the first message queue system may be used to provide fast data access. For the intensive service scenario (for example, the high-throughput data consumption scenario), the data access interface of the second message queue system may be used to provide high-throughput data access.

(4) Higher data reliability is provided through another heterogeneous message storage system on the basis of the original message system.

The data processing method based on a multi-message queue system is described in detail below with specific embodiments.

FIG. 2 is a first flowchart of a data processing method based on a multi-message queue system according to an embodiment of the present disclosure. In the embodiment of the present disclosure, an execution body of the data request processing method may be an electronic device, and the electronic device may be a terminal or a server. As shown in FIG. 2, the data processing method based on a multi-message queue system includes the following steps.

S201: A data read request is received, where the data read request is used to request to read first target data.

In the embodiment of the present disclosure, the data read request may be a data read request sent by a first service, and is used to read the first target data from the multi-message queue system.

The first service may be a service executed in an application. For example, the first service may be an online order service, and the corresponding first target data may be order information. For another example, the first service may be an online alarm service, and the corresponding first target data may be transaction duration of a submitted (unsuccessful transaction) order.

In some embodiments, a service scenario to which the data read request belongs may be determined according to a service identifier. Optionally, the data read request carries a target service identifier. Accordingly, after the data read request is received, the method further includes: acquiring the target service identifier from the data read request, and determining, according to the target service identifier, that the service scenario to which the data read request belongs is an instant service scenario or an intensive service scenario.

Optionally; the instant service scenario includes a low-latency data access mode, and the intensive service scenario includes a high-throughput data access mode.

Optionally, the determining, according to the target service identifier, that the service scenario to which the data read request belongs is an instant service scenario or an intensive service scenario includes: if the target service identifier indicates an online service, determining that the data read request belongs to the instant service scenario; or if the target service identifier indicates an offline service, determining that the data read request belongs to the intensive service scenario.

Exemplarily, as shown in FIG. 1, for example, if the target service identifier is an online application belonging to an online service (that is, indicating an online service), it is determined that the data read request belongs to the instant service scenario. The target service identifier is an online alarm service of an alarm application, which indicates an online service, and it is determined that the data read request belongs to the instant service scenario. For another example, if the target service identifier is an offline data warehouse service, which indicates an offline service, it is determined that the data read request belongs to the intensive service scenario. The target service identifier is an alarm clustering service of an alarm application, which indicates an offline service, and it is determined that the data read request belongs to the intensive service scenario.

In the embodiment of the present disclosure, different data access modes and data access strategies may be provided externally in combination with different service scenarios. For the low-latency online application, a high-performance data access mode may be provided. For an offline big data scenario, a high-throughput data access mode may be provided, which implements that design advantages of different message queue systems are combined, and respective advantages of the multi-message queue system are used to effectively get through the multi-message queue system, so that a hybrid storage message queue system with higher performance and lower cost is provided, thereby saving storage resources and reducing cost overhead.

S202: If the data read request belongs to an instant service scenario, the first target data is read from a first message queue system in a heterogeneous multi-message queue system by using a data access interface of the first message queue system to respond.

In the embodiment of the present disclosure, the heterogeneous multi-message queue system includes an application layer, an access layer, and a storage layer. The storage layer includes a first message queue system, a second message queue system, and a hierarchical storage management service. Optionally, data management is performed between the first message queue system and the second message queue system through the hierarchical storage management service.

It should be noted that the service data stored in the first message queue system is referred to as local data, and the data stored in the second message queue system is referred to as remote data. The first message queue system is referred to as a local storage system, and the second message queue system is referred to as a remote storage system.

The instant service scenario includes a low-latency data access mode. According to different access strategies, the low-latency data access mode may be further classified into: a data access strategy based on local and remote and a data access strategy based on hot and cold data.

The two data access strategies are described below with specific embodiments, respectively.

In some embodiments, the first target data may be read from the first message queue system by using the data access interface of the first message queue system in the heterogeneous multi-message queue system to respond, according to the data access strategy based on local and remote.

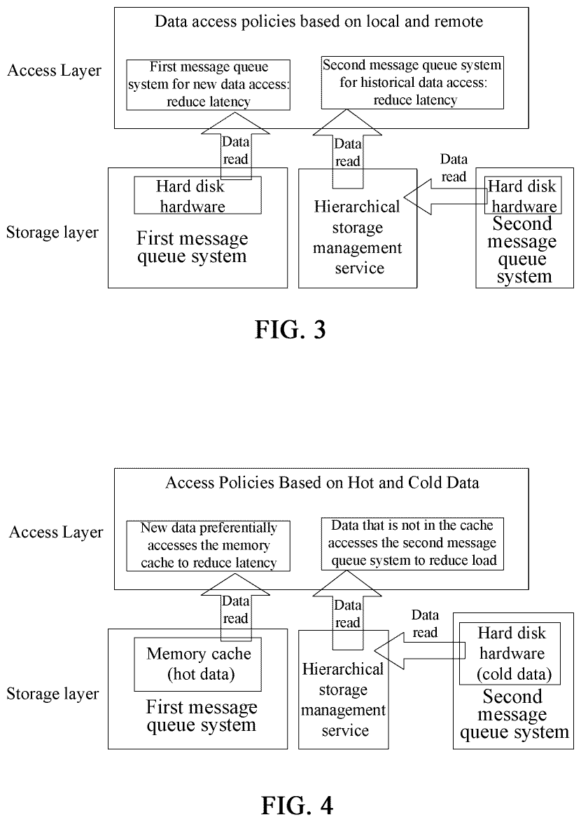

Optionally: as shown in FIG. 3, the reading the first target data from the first message queue system by using the data access interface of the first message queue system in the heterogeneous multi-message queue system to respond includes: reading the first target data from a local storage of the first message queue system by using the data access interface of the first message queue system in the heterogeneous multi-message queue system and adopting a data access strategy based on local and remote, and when there is a shortage of data, reading data from a local storage of the second message queue system to respond.

It should be noted that, in order to further reduce the latency of reading data from the local storage of the message queue system (including the first message queue system and the second message queue system mentioned above), the data access interface of the first message queue system may be used in the present application to read the first target data in a single data reading mode.

In this embodiment, in the data access strategy based on local and remote, if the accessed data is stored in the local storage system (that is, the first message queue system), the data is acquired from the local storage system, and when the data is not stored in the local storage system, the data in the remote storage system (that is, the second message queue system) is attempted to be read. In this mode, the data located in the first message queue system will be accessed preferentially, and the hardware performance of the first message queue system is high, which can ensure the maximization of data access performance.

In other embodiments, the first target data may be read from the first message queue system by using the data access interface of the first message queue system in the heterogeneous multi-message queue system to respond, according to the data access strategy based on hot and cold data. Data that can be hit through accessing a cache is referred to as “hot data”, and data that cannot be hit through accessing a cache is referred to as “cold data”.

Optionally, as shown in FIG. 4, the reading the first target data from the first message queue system by using the data access interface of the first message queue system in the heterogeneous multi-message queue system to respond includes: reading the first target data from a cache of the first message queue system by using the data access interface of the first message queue system in the heterogeneous multi-message queue system and adopting a data access strategy based on hot and cold data, and when there is a shortage of data, reading data from a local storage of the first message queue system to respond, where the cache of the first message queue system is used to store hot data.

In this embodiment, the cache of the local storage system is accessed preferentially, and if the cache can be hit, the cache data is read preferentially: If the cache cannot be hit, the local storage system is read, which can reduce reading the disk data of the local data, thereby reducing the load of the first message queue system.

It should be noted that when there is a shortage of data in the cache of the first message queue system, the data may also be directly read from the local storage of the second message queue system to respond.

In this case, in the data access strategy based on hot and cold data, the cache of the local storage system is accessed preferentially, and if the cache can be hit, the cache data is read preferentially. If the cache cannot be hit, the data in the remote storage system is directly attempted to be read, which further reduces reading the disk data of the local data, thereby further reducing the load of the first message queue system.

In the embodiment of the present disclosure, the load isolation of hot and cold data can be provided through the local storage system and the remote storage system, which avoids the situation that the overall performance of the cluster is affected due to abnormal access to partial data, thereby improving the stability of the multi-message queue system.

It should be noted that in the embodiment of the present disclosure, the association between the data in the first message queue system and the data in the second message queue system may be managed through the hierarchical storage management service. That is, the hierarchical storage management service can keep the correspondence between the service data and the data identifier in the first message queue system consistent with the correspondence between the service data and the data identifier in the second message queue system. For example, if the data identifier corresponding to the service data A in the first message queue system is 001, the data identifier corresponding to the service data A in the second message queue system is 001. In this way, the historical service data in the second message queue system can be accessed through the first message queue system.

Optionally; in the above two access strategies, the data may be read from the local storage of the second message queue system and responded to by the hierarchical storage management service in the single data reading mode, which specifically includes: determining the data identifier of the first target data by the hierarchical storage management service; and reading the first target data from the local storage of the second message queue system and responding to the first target data by the single data reading mode according to the data identifier of the first target data.

S203: If the data read request belongs to an intensive service scenario, the first target data is read from a second message queue system in a heterogeneous multi-message queue system by using a data access interface of the second message queue system to respond.

In the embodiment of the present disclosure, the first message queue system and the second message queue system are deployed with different hardware. The hard disk performance of the first message queue system is higher than that of the second message queue system. Optionally, as shown in FIG. 1, the first message queue system is deployed with solid-state drives, and the second message queue system is deployed with hard disk drives.

It should be noted that the first message queue system and the second message queue system may be various types of message queue systems, and stronger system functions can be implemented by combining the first message queue system and the second message queue system.

In some embodiments, the first message queue system is deployed with high-performance and high-cost solid-state drives to provide low-latency and high-performance data storage services. The second message queue system is deployed with cheap hard disk drives to provide larger storage space and low-cost data storage services. Optionally, the first message queue system may be a RocketMQ (Rocket Message Queue) storage system, and the second message queue system may be a Kafka storage system.

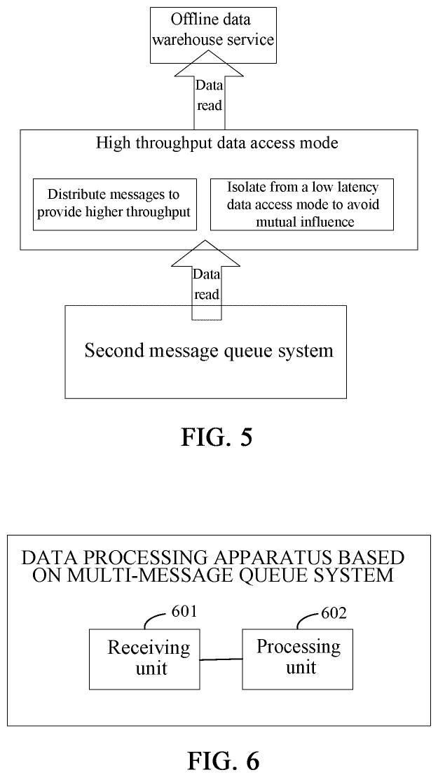

In the embodiment of the present disclosure, as shown in FIG. 5, the intensive service scenario includes a high-throughput data access mode. If the data read request belongs to the high-throughput data access mode, the first target data is read from the second message queue system by using the data access interface of the second message queue system in the heterogeneous multi-message queue system to respond.

It should be noted that in the high-throughput data access mode, the application layer pays more attention to the access throughput of data, that is, more consumer data can be read per second. At this time, the service data is directly accessed through the data access interface of the second message queue system, which can reduce the storage cost of data and realize a high-throughput feature that the first message queue system does not have.

Embodiments of the present disclosure provide a data processing method based on a multi-message queue system, including: receiving a data read request, where the data read request is used to request to read first target data: if the data read request belongs to an instant service scenario, reading the first target data from a first message queue system in a heterogeneous multi-message queue system by using a data access interface of the first message queue system to respond; and if the data read request belongs to an intensive service scenario, reading the first target data from a second message queue system in the heterogeneous multi-message queue system by using a data access interface of the second message queue system to respond. In the technical solution, the data access interface of the first message queue system may be used for the instant service scenario to read the first target data from the first message queue system to respond, and the data access interface of the second message queue system may be used for the intensive service scenario to read the first target data from the second message queue system to respond, thereby implementing that different data access interfaces are provided externally in combination with different service requirement scenarios, so that the processing efficiency of the data request is improved.

It should be noted that when receiving a data write request of any service data, data may be written through the data access interface of the first message queue system. Accordingly, the method further includes: receiving a data write request through the data access interface of the first message queue system in the heterogeneous multi-message queue system, where the data write request is used to request to write second target data: writing the second target data into a local storage of the first message queue system; and writing the second target data into a local storage of the second message queue system by invoking a write mode of writing into a message queue by the hierarchical storage management service based on a specified offset.

In the above case, since the first message queue system is deployed with the hardware of the solid-state drives, which has better write throughput and write latency: the second target data written into the local storage of the first message queue system has higher write performance and lower write latency.

In the embodiment of the present disclosure, the service data in the first message queue system may also be managed through the hierarchical storage management service. For example, cheaper and more stable storage services may be implemented by using hardware and architecture differences of different message queue systems.

In some embodiments, the hierarchical storage management service may also manage the service data according to the storage duration of the service data. The corresponding specific steps may include: invoking the hierarchical storage management service to control the second message queue system to maintain data whose storage duration is greater than a preset time threshold, and deleting the data whose storage duration is greater than the preset time threshold from the first message queue system; and the second message queue system supports the first message queue system to access full data.

The preset time threshold may be set according to specific situations. Exemplarily, the preset time threshold may be 2 days, 3 days, 7 days, etc.

In the embodiment of the present disclosure, data with a longer period may be saved into the second message queue system through the hierarchical storage management service, where the second message queue system may use a low-cost hard disk drive to store data with a longer period, thereby implementing an architecture design with low cost and a longer storage period.

It should be noted that after the data whose storage duration is greater than the preset time threshold in the first message queue system is synchronized to the second message queue system by invoking the hierarchical storage management service, the data may be synchronously deleted in the first message queue system, or may not be synchronously deleted, and the data is deleted after the storage duration is greater than another set preset time threshold.

Exemplarily, the preset time threshold may be 2 days, and the other set preset time threshold may be 7 days. After the data whose storage duration is greater than 2 days is synchronized to the second message queue system, the data may not be synchronously deleted. The data is deleted after the storage duration of the data is greater than 7 days.

In this case, the system can provide more heterogeneous storage replicas by combining the two storage systems, which increases the reliability of data and reduces the problem of data loss caused by hardware failure of a single system.

FIG. 6 is a schematic structural diagram of a data processing device based on a multi-message queue system according to an embodiment of the present disclosure. As shown in FIG. 6, the data request processing device includes:
a receiving unit 601, configured to receive a data read request, where the data read request is used to request to read first target data;
a processing unit 602, configured to: if the data read request belongs to an instant service scenario, read the first target data from a first message queue system in a heterogeneous multi-message queue system by using a data access interface of the first message queue system to respond; and
the processing unit 602 is further configured to: if the data read request belongs to an intensive service scenario, read the first target data from a second message queue system in the heterogeneous multi-message queue system by using a data access interface of the second message queue system to respond.

According to one or more embodiments of the present disclosure, the data read request carries a target service identifier, and the device further includes a determining unit, where the determining unit is configured to acquire the target service identifier from the data read request, and determine, according to the target service identifier, that a service scenario to which the data read request belongs is an instant service scenario or an intensive service scenario.

According to one or more embodiments of the present disclosure, the determining unit is configured to: if the target service identifier indicates an online service, determine that the data read request belongs to the instant service scenario; and if the target service identifier indicates an offline service, determine that the data read request belongs to the intensive service scenario.

According to one or more embodiments of the present disclosure, the device further includes a data receiving unit, where the data receiving unit is configured to: receive a data write request through the data access interface of the first message queue system in the heterogeneous multi-message queue system, where the data write request is used to request to write second target data: write the second target data into the local storage of the first message queue system; and write the second target data into the local storage of the second message queue system by invoking a write mode of writing into a message queue by the hierarchical storage management service based on a specified offset.

According to one or more embodiments of the present disclosure, the device further includes a data scheduling unit, where the data receiving unit is configured to: invoke the hierarchical storage management service to control the second message queue system to maintain data whose storage duration is greater than the preset time threshold, and delete the data whose storage duration is greater than the preset time threshold from the first message queue system; and the second message queue system supports the first message queue system to access the full data.

According to one or more embodiments of the present disclosure, the processing unit 602, when reading the first target data from the first message queue system by using the data access interface of the first message queue system in the heterogeneous multi-message queue system to respond, is further configured to: read the first target data from the local storage of the first message queue system by using the data access interface of the first message queue system in the heterogeneous multi-message queue system and adopting the data access strategy based on local and remote, and when there is a shortage of data, read data from the local storage of the second message queue system to respond.

According to one or more embodiments of the present disclosure, the processing unit 602, when reading the first target data from the first message queue system by using the data access interface of the first message queue system in the heterogeneous multi-message queue system to respond, is further configured to: read the first target data from a cache of the first message queue system by using the data access interface of the first message queue system in the heterogeneous multi-message queue system and adopting a data access strategy based on hot and cold data to respond, and when there is a shortage of data, read data from the local storage of the first message queue system to respond, where the cache of the first message queue system is used to store hot data.

According to one or more embodiments of the present disclosure, the first message queue system and the second message queue system are deployed with different hardware, where a hard disk performance of the first message queue system is higher than that of the second message queue system.

According to one or more embodiments of the present disclosure, the first message queue system is deployed with solid-state drives, and the second message queue system is deployed with hard disk drives.

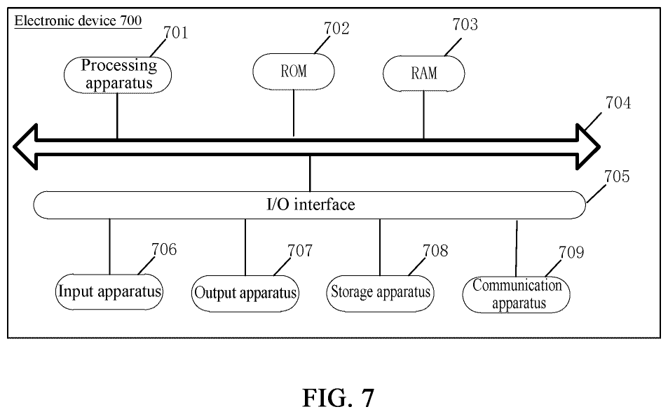

Reference is made to FIG. 7, which illustrates a schematic structural diagram of an electronic device 700 according to embodiments of the present disclosure. The electronic device 700 may be a terminal device or a server. The terminal device may include, but is not limited to, a mobile terminal such as a mobile phone, a laptop, a digital broadcast receiver, a personal digital assistant (abbreviated as PDA), a tablet computer, a portable media player (abbreviated as PMP), an in-vehicle terminal (such as an in-vehicle navigation terminal), etc., and a fixed terminal such as a digital TV, a desktop computer, etc. The electronic device shown in FIG. 7 is only an example, and should not impose any limitation on the function and scope of use of the embodiments of the present disclosure.

As shown in FIG. 7, the electronic device 700 may include a processing apparatus (such as a central processing unit, a graphics processing unit, etc.) 701, which may perform various appropriate actions and processing according to a program stored in a read-only memory (abbreviated as ROM) 702 or a program loaded from a storage apparatus 708 into a random access memory (abbreviated as RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatus may be connected to the I/O interface 705: an input apparatus 706 including, for example, a touchscreen, a touchpad, a keyboard, a mouse, a camera, a microphone, an accelerometer, a gyroscope, etc.; an output apparatus 707 including, for example, a liquid crystal display (abbreviated as LCD), a speaker, a vibrator, etc.; a storage apparatus 708 including, for example, a magnetic tapc, a hard disk, etc.; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the illustrated apparatuses. Alternatively, more or fewer apparatuses may be implemented or provided.

Particularly, according to the embodiments of the present disclosure, the processes described above with reference to the flowcharts may be implemented as a computer software program. For example, an embodiment of the present disclosure includes a computer program product, which includes a computer program carried on a computer-readable medium, where the computer program includes program codes for executing the methods shown in the flowcharts. In such an embodiment, the computer program may be downloaded and installed from the network through the communication apparatus 709, or may be installed from the storage apparatus 708, or may be installed from the ROM 702. When the computer program is executed by the processing apparatus 701, the above-mentioned functions defined in the methods of the embodiments of the present disclosure are executed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier wave and carries computer-readable program codes therein. The data signal propagating in such a manner may take a plurality of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to an electric wire, an optical cable, radio frequency (RF), etc., or any suitable combination thereof.

The above-mentioned computer-readable medium may be included in the above-mentioned electronic device, or may exist alone without being assembled into the electronic device.

The above-mentioned computer-readable medium carries one or more programs, and when the one or more programs are executed by the electronic device, the electronic device is caused to execute the methods shown in the above-mentioned embodiments.

The computer program codes used to perform the operations of the present disclosure may be written in one or more programming languages or a combination thereof, where the above-mentioned programming languages include object-oriented programming languages such as Java. Smalltalk. C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or a server. In the scenario involving the remote computer, the remote computer may be connected to the user's computer through any kind of network, including a local area network (abbreviated as LAN) or a wide area network (abbreviated as WAN), or may be connected to an external computer (for example, through the Internet using an Internet service provider).

The flowcharts and block diagrams in the drawings show possible architecture, functions, and operations of the system, method, and computer program product according to the embodiments of the present disclosure. In this regard, each block in the flowchart or block diagram may represent a module, program segment, or part of codes, and the module, program segment, or part of codes contains one or more executable instructions for implementing specified logic functions. It should also be noted that, in some alternative implementations, the functions marked in the blocks may also occur in a different order than those marked in the drawings. For example, two blocks shown in succession may actually be performed substantially in parallel. or may sometimes be performed in a reverse order, depending on the functions involved. It should also be noted that each block in the block diagram and/or flowchart and a combination of blocks in the block diagram and/or flowchart may be implemented by a dedicated hardware-based system that performs specified functions or operations, or may be implemented by a combination of dedicated hardware and computer instructions.

The units involved in the embodiments of the present disclosure may be implemented by software or hardware. The name of a unit does not constitute a limitation of the unit itself under certain circumstances. For example, a first acquiring unit may also be described as “a unit for acquiring at least two Internet protocol addresses”.

The functions described above herein may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical. electromagnetic, infrared, or semiconductor system, apparatus or device, or any suitable combination thereof. More specific examples of the machine-readable storage medium may include an electrical connection with one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof.

In a first aspect, according to one or more embodiments of the present disclosure, a data processing method based on a multi-message queue system is provided, including:
receiving a data read request, where the data read request is used to request to read first target data;
if the data read request belongs to an instant service scenario, reading the first target data from a first message queue system in the multi-message queue system by using a data access interface of the first message queue system to respond, where the multi-message queue system is a heterogeneous multi-message queue system; and
if the data read request belongs to an intensive service scenario, reading the first target data from a second message queue system in the multi-message queue system by using a data access interface of the second message queue system to respond, where the multi-message queue system is a heterogeneous multi-message queue system.

According to one or more embodiments of the present disclosure, the data read request carries a target service identifier, and the method further includes: acquiring the target service identifier from the data read request, and determining, according to the target service identifier, that a service scenario to which the data read request belongs is an instant service scenario or an intensive service scenario.

According to one or more embodiments of the present disclosure, if the target service identifier indicates an online service, it is determined that the data read request belongs to the instant service scenario; and if the target service identifier indicates an offline service, it is determined that the data read request belongs to the intensive service scenario.

According to one or more embodiments of the present disclosure, the method further includes: receiving a data write request through a data access interface of the first message queue system in the heterogeneous multi-message queue system, where the data write request is used to request to write second target data: writing the second target data into a local storage of the first message queue system; and writing the second target data into a local storage of the second message queue system by invoking a write mode of writing into a message queue by the hierarchical storage management service based on a specified offset.

According to one or more embodiments of the present disclosure, the method further includes: invoking the hierarchical storage management service to control the second message queue system to maintain data whose storage duration is greater than a preset time threshold, and deleting the data whose storage duration is greater than the preset time threshold from the first message queue system; and the second message queue system supports the first message queue system to access the full data.

According to one or more embodiments of the present disclosure, the reading the first target data from the first message queue system by using the data access interface of the first message queue system in the heterogeneous multi-message queue system to respond includes: reading the first target data from a local storage of the first message queue system by using the data access interface of the first message queue system in the heterogeneous multi-message queue system and adopting a data access strategy based on local and remote to respond, and when there is a shortage of data, reading data from a local storage of the second message queue system to respond.

According to one or more embodiments of the present disclosure, the reading the first target data from the first message queue system by using the data access interface of the first message queue system in the heterogenous multi-message queue system to respond includes: reading the first target data from a cache of the first message queue system by using the data access interface of the first message queue system in the heterogeneous multi-message queue system and adopting a data access strategy based on hot and cold data to respond, and when there is a shortage of data, reading data from a local storage of the first message queue system to respond, where the cache of the first message queue system is used to store hot data.

According to one or more embodiments of the present disclosure, the first message queue system and the second message queue system are deployed with different hardware, where a hard disk performance of the first message queue system is higher than that of the second message queue system.

According to one or more embodiments of the present disclosure, the first message queue system is deployed with solid-state drives, and the second message queue system is deployed with hard disk drives.

In a second aspect, according to one or more embodiments of the present disclosure, a data processing device based on a multi-message queue system is provided, including:
a receiving unit, configured to receive a data read request, where the data read request is used to request to read first target data;
a processing unit, configured to: if the data read request belongs to an instant service scenario, read the first target data from a first message queue system in the multi-message queue system by using a data access interface of the first message queue system to respond, where the multi-message queue system is a heterogeneous multi-message queue system; and
the processing unit is further configured to: if the data read request belongs to an intensive service scenario, read the first target data from a second message queue system in the multi-message queue system by using a data access interface of the second message queue system to respond, where the multi-message queue system is a heterogeneous multi-message queue system.

According to one or more embodiments of the present disclosure, the data read request carries a target service identifier, and the device further includes a determining unit, where the determining unit is configured to acquire the target service identifier from the data read request, and determine, according to the target service identifier, that a service scenario to which the data read request belongs is an instant service scenario or an intensive service scenario.

According to one or more embodiments of the present disclosure, the determining unit is configured to: if the target service identifier indicates an online service, determine that the data read request belongs to the instant service scenario; and if the target service identifier indicates an offline service, determine that the data read request belongs to the intensive service scenario.

According to one or more embodiments of the present disclosure, the device further includes a data receiving unit, where the data receiving unit is configured to: receive a data write request through the data access interface of the first message queue system in the heterogeneous multi-message queue system, where the data write request is used to request to write second target data: write the second target data into the local storage of the first message queue system; and write the second target data into the local storage of the second message queue system by invoking a write mode of writing into a message queue by the hierarchical storage management service based on a specified offset.

According to one or more embodiments of the present disclosure, the device further includes a data scheduling unit, where the data scheduling unit is configured to: invoke the hierarchical storage management service to control the second message queue system to maintain data whose storage duration is greater than the preset time threshold, and delete the data whose storage duration is greater than the preset time threshold from the first message queue system; and the second message queue system supports the first message queue system to access the full data.

According to one or more embodiments of the present disclosure, the processing unit, when reading the first target data from the first message queue system by using the data access interface of the first message queue system in the heterogeneous multi-message queue system to respond, is further configured to: read the first target data from the local storage of the first message queue system by using the data access interface of the first message queue system in the heterogeneous multi-message queue system and adopting the data access strategy based on local and remote to respond, and when there is a shortage of data, read data from the local storage of the second message queue system to respond.

According to one or more embodiments of the present disclosure, the processing unit, when reading the first target data from the first message queue system by using the data access interface of the first message queue system in the heterogeneous multi-message queue system to respond, is further configured to: read the first target data from a cache of the first message queue system by using the data access interface of the first message queue system in the heterogeneous multi-message queue system and adopting a data access strategy based on hot and cold data to respond, and when there is a shortage of data, read data from the local storage of the first message queue system to respond, where the cache of the first message queue system is used to store hot data.

According to one or more embodiments of the present disclosure, the first message queue system and the second message queue system are deployed with different hardware, where a hard disk performance of the first message queue system is higher than that of the second message queue system.

According to one or more embodiments of the present disclosure, the first message queue system is deployed with solid-state drives, and the second message queue system is deployed with hard disk drives.

In a third aspect, according to one or more embodiments of the present disclosure, an electronic device is provided, including: at least one processor and a memory:
where the memory stores computer-executable instructions; and
the at least one processor executes the computer-executable instructions stored in the memory, to enable the at least one processor to perform the data processing method based on a multi-message queue system according to the first aspect and various possible designs of the first aspect.

In a fourth aspect, according to one or more embodiments of the present disclosure, a computer-readable storage medium is provided, where the computer-readable storage medium stores computer-executable instructions, and when a processor executes the computer-executable instructions, the data processing method based on a multi-message queue system according to the first aspect and various possible designs of the first aspect is implemented.

In a fifth aspect, according to one or more embodiments of the present disclosure, a computer program product is provided, including a computer program, where when the computer program is executed by a processor, the data processing method based on a multi-message queue system according to the first aspect and various possible designs of the first aspect is implemented.

The above description is merely preferred embodiments of the present disclosure and an explanation of the applied technical principles. Those skilled in the art should understand that the disclosure scope involved in the present disclosure is not limited to the technical solutions formed by the specific combination of the above-mentioned technical features, and should also cover other technical solutions formed by any combination of the above-mentioned technical features or equivalent features thereof without departing from the above-mentioned disclosed concept. For example, a technical solution formed by replacing the above-mentioned features with the technical features with similar functions disclosed in the present disclosure (but not limited to).

In addition, although operations are depicted in a particular order, this should not be understood as requiring these operations to be performed in the specific order shown or in a sequential order. Under certain circumstances, multitasking and parallel processing may be advantageous. Likewise, although the above discussion contains several specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

I/We claim:

1. A data processing method based on a multi-message queue system, comprising:
receiving a data read request, the data read request being used to request to read first target data;
in response to the data read request belonging to an instant service scenario, reading the first target data from a first message queue system in the multi-message queue system by using a data access interface of the first message queue system to respond, wherein the multi-message queue system is a heterogeneous multi-message queue system; and
in response to the data read request belonging to an intensive service scenario, reading the first target data from a second message queue system in the multi-message queue system by using a data access interface of the second message queue system to respond.

2. The data processing method according to claim 1, wherein the data read request carries a target service identifier, and the method further comprises:
acquiring the target service identifier from the data read request, and determining, based on the target service identifier, that a service scenario to which the data read request belongs is the instant service scenario or the intensive service scenario.

3. The data processing method according to claim 2, wherein:
in response to the target service identifier indicating an online service, determining that the data read request belongs to the instant service scenario; and
in response to the target service identifier indicating an offline service, determining that the data read request belongs to the intensive service scenario.

4. The data processing method according to claim 1, wherein the method further comprises:
receiving a data write request through the data access interface of the first message queue system in the heterogeneous multi-message queue system, the data write request being used to request to write second target data;
writing the second target data into a local storage of the first message queue system; and
writing the second target data into a local storage of the second message queue system by invoking a write mode of writing into a message queue by a hierarchical storage management service based on a specified offset.

5. The data processing method according to claim 1, wherein the method further comprises:
invoking a hierarchical storage management service to control the second message queue system to maintain data whose storage duration is greater than a preset time threshold, and deleting the data whose storage duration is greater than the preset time threshold from the first message queue system; wherein the second message queue system supports the first message queue system to access full data.

6. The data processing method according to claim 1, wherein reading the first target data from the first message queue system in the multi-message queue system by using the data access interface of the first message queue system to respond comprises:
reading the first target data from a local storage of the first message queue system by using the data access interface of the first message queue system in the heterogeneous multi-message queue system and adopting a data access strategy based on local and remote, and in response to a shortage of data, reading data from a local storage of the second message queue system to respond.

7. The data processing method according to claim 1, wherein reading the first target data from the first message queue system in the multi-message queue system by using the data access interface of the first message queue system to respond comprises:
reading the first target data from a cache of the first message queue system by using the data access interface of the first message queue system in the heterogeneous multi-message queue system and adopting a data access strategy based on hot and cold data, and in response to a shortage of data, reading data from a local storage of the first message queue system to respond, wherein the cache of the first message queue system is used to store hot data.

8. The data processing method according to claim 1, wherein the first message queue system and the second message queue system are deployed with different hardware, and a hard disk performance of the first message queue system is higher than that of the second message queue system.

9. The data processing method according to claim 7, wherein the first message queue system is deployed with solid-state drives, and the second message queue system is deployed with hard disk drives.

10. An electronic device, comprising: a processor and a memory:
wherein the memory stores computer-executable instructions; and
wherein the processor executes the computer-executable instructions stored in the memory, to cause the processor to:
receive a data read request, the data read request being used to request to read first target data;
in response to the data read request belonging to an instant service scenario, read the first target data from a first message queue system in the multi-message queue system by using a data access interface of the first message queue system to respond, wherein the multi-message queue system is a heterogeneous multi-message queue system; and
in response to the data read request belonging to an intensive service scenario, read the first target data from a second message queue system in the multi-message queue system by using a data access interface of the second message queue system to respond.

11. The electronic device according to claim 10, wherein the data read request carries a target service identifier, and the computer-executable instructions further cause the processor to:
acquire the target service identifier from the data read request, and determine, based on the target service identifier, that a service scenario to which the data read request belongs is the instant service scenario or the intensive service scenario.

12. The electronic device according to claim 11, wherein the computer-executable instructions further cause the processor to:
in response to the target service identifier indicating an online service, determine that the data read request belongs to the instant service scenario; and
in response to the target service identifier indicating an offline service, determine that the data read request belongs to the intensive service scenario.

13. The electronic device according to claim 10, wherein the computer-executable instructions further cause the processor to:
receive a data write request through the data access interface of the first message queue system in the heterogeneous multi-message queue system, the data write request being used to request to write second target data;
write the second target data into a local storage of the first message queue system; and
write the second target data into a local storage of the second message queue system by invoking a write mode of writing into a message queue by a hierarchical storage management service based on a specified offset.

14. The electronic device according to claim 10, wherein the computer-executable instructions further cause the processor to:
invoke a hierarchical storage management service to control the second message queue system to maintain data whose storage duration is greater than a preset time threshold, and delete the data whose storage duration is greater than the preset time threshold from the first message queue system: wherein the second message queue system supports the first message queue system to access full data.

15. The electronic device according to claim 10, wherein the computer-executable instructions to read the first target data from the first message queue system in the multi-message queue system by using the data access interface of the first message queue system to respond comprise instructions to:
read the first target data from a local storage of the first message queue system by using the data access interface of the first message queue system in the heterogeneous multi-message queue system and adopting a data access strategy based on local and remote, and in response to a shortage of data, read data from a local storage of the second message queue system to respond.

16. The electronic device according to claim 10, wherein the computer-executable instructions to read the first target data from the first message queue system in the multi-message queue system by using the data access interface of the first message queue system to respond comprise instructions to:
read the first target data from a cache of the first message queue system by using the data access interface of the first message queue system in the heterogeneous multi-message queue system and adopting a data access strategy based on hot and cold data, and in response to a shortage of data, read data from a local storage of the first message queue system to respond, wherein the cache of the first message queue system is used to store hot data.

17. The electronic device according to claim 10, wherein the first message queue system and the second message queue system are deployed with different hardware, and a hard disk performance of the first message queue system is higher than that of the second message queue system.

18. The electronic device according to claim 16, wherein the first message queue system is deployed with solid-state drives, and the second message queue system is deployed with hard disk drives.

19. A non-transitory computer-readable storage medium, wherein the computer-readable storage medium stores computer-executable instructions, and the computer-executable instructions, when executed by a processor, cause a computer to:
receive a data read request, the data read request being used to request to read first target data;
in response to the data read request belonging to an instant service scenario, read the first target data from a first message queue system in the multi-message queue system by using a data access interface of the first message queue system to respond, wherein the multi-message queue system is a heterogeneous multi-message queue system; and
in response to the data read request belonging to an intensive service scenario, read the first target data from a second message queue system in the multi-message queue system by using a data access interface of the second message queue system to respond.

20. The non-transitory computer-readable storage medium according to claim 19, wherein the data read request carries a target service identifier, and the computer-executable instructions further cause the computer to:
acquire the target service identifier from the data read request, and determine, based on the target service identifier, that a service scenario to which the data read request belongs is the instant service scenario or the intensive service scenario.
